(19) United States
(12) Patent Application Publication
(10) Pub. No.: US 2015/0016015 A1
(43) Pub. Date: Jan. 15, 2015

(54) MULTI-LAYERED CAPACITOR

(71) Applicant: SAMSUNG ELECTRO-MECHANICS CO., LTD., Suwon-si (KR)

(72) Inventors: Kyo Kwang LEE, Suwon-si (KR); Doo Young KIM, Suwon-si (KR); Hae Sock CHUNG, Suwon-si (KR)

(73) Assignee: SAMSUNG ELECTRO-MECHANICS CO., LTD., Suwon-si (KR)

(21) Appl. No.: 14/076,018

(22) Filed: Nov. 8, 2013

(30) Foreign Application Priority Data
Jul. 11, 2013 (KR) 10-2013-0081645

(51) Int. Cl. H01G 4/30

(52) U.S. Cl. CPC H01G 4/30
USPC 361/301.4

(57) ABSTRACT

Disclosed herein is a multi-layered capacitor including: a multi-layered body which includes a capacity part formed by multi-layering a dielectric layer and an internal electrode and a cover part formed by multi-layering the dielectric layer; and a pair of external terminals disposed on both sides of the multi-layered body, in which the cover part is formed by multi-layering a first dielectric layer made of a ferroelectric material and a second dielectric layer made of a paraelectric material, thereby implementing thinness, miniaturization, and high capacity and increasing durability.

This application claims the benefit under 35 U.S.C. Section 119 of Korean Patent Application Serial No. 10-2013-0081645 entitled “Multi-layered Capacitor” filed on Jul. 11, 2013, which is hereby incorporated by reference in its entirety into this application.

### BACKGROUND OF THE INVENTION

1. Technical Field

The present invention relates to a multi-layered capacitor, and more particular, to a multi-layered capacitor including a paraelectric material.

2. Description of the Related Art

A multi-layered capacitor (MLCC) is a chip-type capacitor which is mounted in a printed circuit board for various electronic products, such as a mobile communication terminal, a notebook computer, and a personal digital assistant (PDA), to serve to charge or discharge electricity and has widely used as components of various electronic devices since the MLCC may be miniaturized, may secure high capacity, and may be easily mounted.

Generally, the multi-layered capacitor has a structure in which internal electrodes are alternately multi-layered between a plurality of dielectric layers. Herein, as a ceramic material forming the dielectric layer, a ferroelectric material, such as barium titanate having a relatively high permittivity, has been generally used.

However, the ferroelectric material has weak material strength and bending strength characteristics and therefore may have cracks generated therein due to an external impact, such that problems of reduction in capacity and short-circuit may occur.

Further, the ferroelectric material has piezoelectricity and when voltage is applied to the capacitor, a stress is generated in a body of the capacitor in each direction of X, Y, and Z, such that vibrations may be generated. When the vibration is transferred to a mounting substrate of the capacitor, the whole substrate becomes an acoustic radiating surface to generate a vibration sound and in severe cases, cracks may be generated in the capacitor.

To solve the problems, Japanese Patent Laid-Open Publication No. 1997-180956 discloses that an intermediate layer is disposed at a central portion in the capacitor so as to reduce a stress.

However, when a separate member is disposed in the capacitor, it is difficult to implement thinness and miniaturization of the capacitor and a dielectric layer or an internal electrode may not be provided as much as a space occupied by the intermediate layer, such that the large-capacity capacitor may not be easily implemented.

Further, the capacitor may have cracks generated therein at the time of firing due to a difference in coefficient of thermal expansion between materials forming the intermediate layer and the dielectric layer.

### RELATED ART DOCUMENT

### Patent Document

(Patent Document 1) Japanese Patent Laid-Open Publication No. 1997-180956

### SUMMARY OF THE INVENTION

An object of the present invention is to provide a multi-layered capacitor having reliability despite vibrations generated due to an external impact or piezoelectricity by changing a structure of a cover part without having a separate member embedded therein.

According to an exemplary embodiment of the present invention, there is provided a multi-layered capacitor, including: a multi-layered body which includes a capacity part formed by multi-layering a dielectric layer and an internal electrode and a cover part formed by multi-layering the dielectric layer; and a pair of external terminals disposed on both sides of the multi-layered body, wherein the cover part is formed by multi-layering a first dielectric layer made of a ferroelectric material and a second dielectric layer made of a paraelectric material.

The first dielectric layer and the second dielectric layer may be alternately multi-layered.

A ratio (T₁/T₂) of a thickness T₁ of the first dielectric layer to a thickness T₂ of the second dielectric layer may be 0.2 to 1.5.

The cover part may be disposed on and beneath the capacity part.

The ferroelectric material may include any one or two or more mixtures selected from a group consisting of barium titanate (BaTiO₃)-based ceramic, Pb-based complex perovskite based ceramic, and strontium titanate (SrTiO₃) based ceramic.

The paraelectric material may include any one or two or more mixtures selected from a group consisting of calcium zirconate (CaZrO₃)-based ceramic, barium zirconate (BaZrO₃)-based ceramic, and strontium zirconate (SrZrO₃)-based ceramic.

A dielectric layer forming the capacity part may be made of a ferroelectgric material.

According to another exemplary embodiment of the present invention, there is provided a multi-layered capacitor, including: a multi-layered body which includes a capacity part formed by multi-layering a dielectric layer and an internal electrode and a cover part formed by multi-layering the dielectric layer; and a pair of external terminals disposed on both sides of the multi-layered body, wherein the cover part includes a ferroelectric layer formed by multi-layering the dielectric layer made of a ferroelectric material in plural and a paraelectric layer formed by multi-layering the dielectric layer made of a ferroelectric material in plural.

The ferroelectric layer may be configured of an upper ferroelectric layer and a lower ferroelectric layer and the paraelectric layer may be disposed between the upper ferroelectric layer and the lower ferroelectric layer.

A ratio (T₃/T_{B}) of a thickness T₃ of the paraelectric layer to a thickness T_{B} of the cover part may be 0.1 to 0.9.

### BRIEF DESCRIPTION OF THE DRAWINGS

FIG. 1 is a perspective view of a multi-layered capacitor according to an exemplary embodiment of the present invention.

FIG. 2 is a longitudinal cross-sectional view of FIG. 1.

FIG. 3 is a graph of comparing bending strength characteristics between a multi-layered capacitor according to the related art and a multi-layered capacitor according to the exemplary embodiment of the present invention.

FIGS. 4 and 5 are cross-sectional views of a multi-layered capacitor according to another exemplary embodiment of the present invention.

FIG. 6 is a graph of comparing bending strength characteristics between a multi-layered capacitor according to the related art and a multi-layered capacitor according to another exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

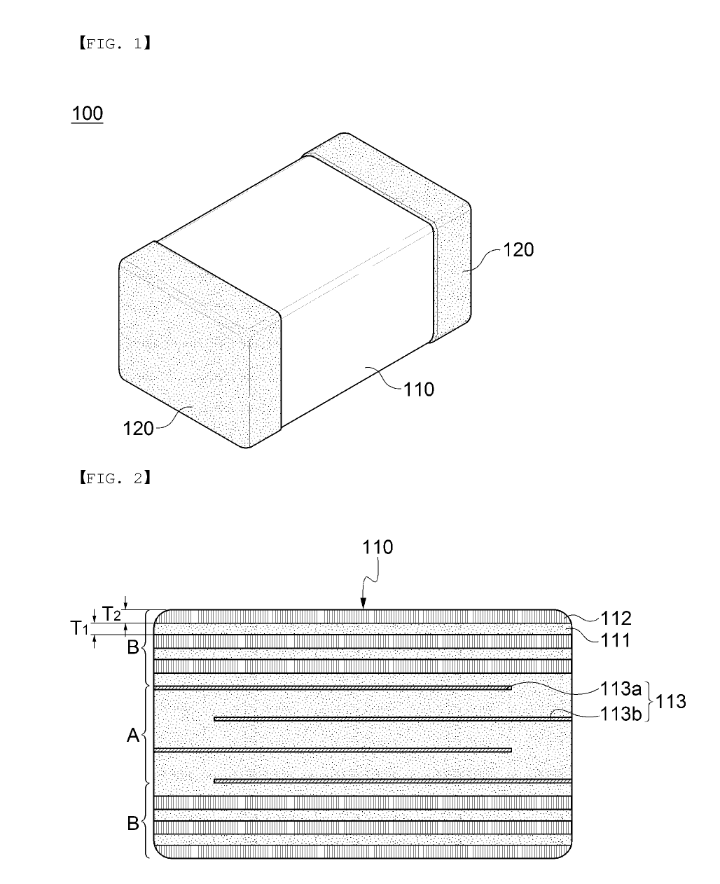

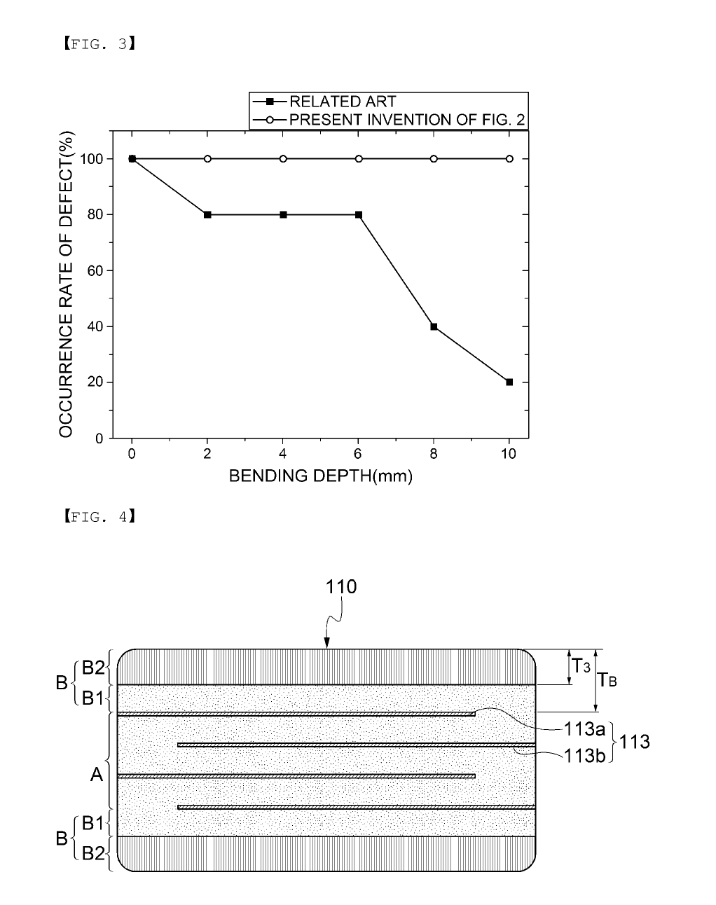

FIG. 1 is a perspective view of a multi-layered capacitor according to an exemplary embodiment of the present invention and FIG. 2 is a longitudinal cross-sectional view of FIG. 1. Additionally, components shown in the accompanying drawings are not necessarily shown to scale. For example, sizes of some components shown in the accompanying drawings may be exaggerated as compared with other components in order to assist in the understanding of the exemplary embodiments of the present invention.

Referring to FIGS. 1 and 2, a multi-layered capacitor 100 according to an exemplary embodiment of the present invention may include a multi-layered body 110 and a pair of external terminals 120 disposed at both ends of the multi-layered body 110.

The multi-layered body 110 may be divided into a capacity part A in which an internal electrode 113 is embedded and a cover part B which is formed by multi-layering only a multi-layered dielectric layer without an internal electrode 113.

In detail, the capacity part A may be formed by multi-layering the dielectric layer having the internal electrode 113 formed on one surface thereof. The capacity part A is completed by a sintering process after being multi-layered, such that a boundary between adjacent dielectric layers may be integrated enough not to be differentiated from each other.

As a material of the dielectric layer forming the capacity part A, a ferroelectric material may be used. Therefore, the multi-layered capacitor 100 according to the exemplary embodiment of the present invention may basically have a high-K-based class II-structure.

Further, the internal electrode 113 may be configured of a first internal electrode 113a which is connected to any one of the pair of external terminals 120 and has (+) polarity or (−) polarity and a second internal electrode 113b which is connected to the other external terminal 120 and has (−) polarity or (+) polarity.

The internal electrode 113 has a metal thin film form by sintering a metal paste using one or more selected from Ni, Al, Fe, Cu, Ti, Cr, Au, Ag, Pd, and Pt all of which has excellent electrical conductivity or a metal compound thereof as main components. In this case, the first internal electrode 113a and the second internal electrode 113b has different interlayer directions and have ends exposed on a side of the multi-layered body 110 to be connected to the external terminal 120.

The cover part B may be formed of a dielectric layer, in detail, a multi-layering of a first dielectric layer 111 and a second dielectric layer 112 of which one surface is not provided with the internal electrode 113. The cover part B is a layer for protecting the capacitor from vibrations generated due to an external impact or piezoelectricity and may be disposed on and beneath the capacity part A.

Herein, the first dielectric layer 111 and the second dielectric layer 112 may be alternately multi-layered, in which similar to the capacity part A, the first dielectric layer 111 may be made of a high-K ferroelectric material, for example, any one or two or more mixtures selected from a group consisting of barium titanate (BaTiO₃)-based ceramic, Pb-based complex perovskite based ceramic, and strontium titanate (SrTiO₃) based ceramic.

Further, the second dielectric layer 112 may be made of a paraelectric material having excellent material strength and bending strength, for example, any one or two or more mixtures selected from a group consisting of calcium zirconate (CaZrO₃)-based ceramic, barium zirconate (BaZrO₃)-based ceramic, and strontium zirconate (SrZrO₃)-based ceramic.

That is, in the multi-layered capacitor 100 according to the exemplary embodiment of the present invention, the capacity part A is made of a ferroelectric material to have a high-K-based class II structure and to supplement the reduction in durability due to the ferroelectric material having weak strength and piezoelectricity, some layers of the cover part B is made of a paraelectric material having excellent material strength and bending strength, that is, the second dielectric layer 112.

FIG. 3 is a graph of comparing the bending strength characteristics between the multi-layered capacitor according to the related art in which the overall element is made of a ferroelectric material of barium titanate (BaTiO₃) and the multi-layered capacitor according to the exemplary embodiment of the present invention of FIG. 2. Both of the multi-layered capacitors according to the related art and the exemplary embodiment of the present invention used a capacitor of 1005 size and 1 μF and the change rate of capacity of the multi-layered capacitor depending on the bent degree of the substrate after the capacitor is mounted on the substrate was observed.

In the graph, a bending depth [mm] of an X coordinate represents a bent degree of the substrate and a survival rate (%) of a y coordinate represents a ratio of a product in which the change rate of capacity of the capacitor is equal to or less than 10%. When the substrate is bent due to the weak bending strength characteristic of the capacitor to generate cracks in the capacitor, the capacity of the capacitor is largely changed. As a result, when the change rate of capacity generally exceeds 10%, the capacitor may be determined to be defective.

Referring to the graph of FIG. 3, when the capacitor according to the related art has a bending depth of 2 mm, it may be appreciated that the survival rate (%) is reduced below 100%. However, according to the exemplary embodiment of the present invention, even though the survival rate becomes than above, it may be appreciated that the survival rate (%) may continuously maintain 100% without causing the defect. The reason is that the second dielectric layer 112 made of a paraelectric material having excellent material strength and bending strength suppresses a stress due to bending or vibrations. Therefore, the multi-layered capacitor 100 according to the exemplary embodiment of the present invention may have durability larger than that of the related art.

Meanwhile, when the whole of the cover part B according to the exemplary embodiment of the present invention is formed of the second dielectric layer 112, that is, a paraelectric material, the bending strength characteristic may be more improved. However, in this case, a component rate (%) of the ferroelectric material is reduced and thus the overall permittivity may be largely reduced. Above all, cracks may be generated due to a mismatching of coefficient of thermal expansion (CTE) at the time of firing due to different characteristics of a paraelectric material and a ferroelectric material. Therefore, according to the exemplary embodiment of the present invention, the cover part B may be formed by alternately multi-layering the first dielectric layer 111 and the second dielectric layer 112.

However, when a thickness T₂ of the second dielectric layer 112 alternately multi-layered herein is much thinner than that of the first dielectric layer 111, the bending strength characteristic of the capacitor may be reduced, while when the thickness T₂ is much thicker than that of the first dielectric layer 111, the overall permittivity of the capacitor is reduced and the cracks due to the difference in CTE may occur. Therefore, the ratio (T₁/T₂) of a thickness T₁ of the first dielectric layer 111 to the thickness T₂ of the second dielectric layer 112 may be set within a range of 0.2 to 1.5.

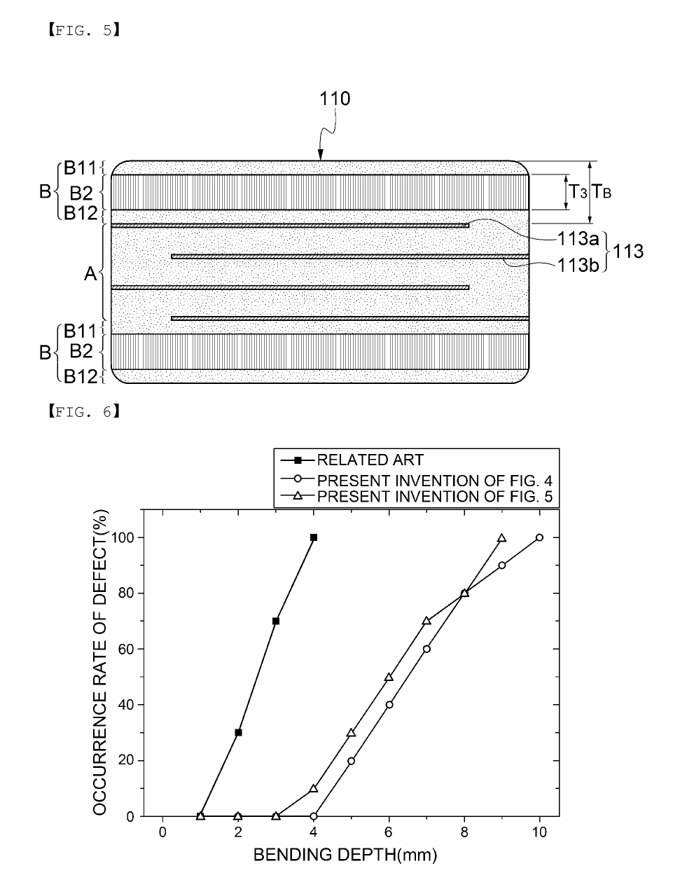

FIG. 4 is a cross-sectional view of a multi-layered capacitor according to another embodiment of the present invention.

Referring to FIG. 4, in the multi-layered capacitor according to another exemplary embodiment of the present invention, the cover part B may be configured of a ferroelectric layer B1 which is formed by multi-layering the dielectric layer made of a ferroelectric material in plural and a paraelectric layer B2 which is formed by multi-layering the dielectric layer made of a paraelectric material in plural. Herein, the dielectric layer forming the ferroelectric layer B1 and the dielectric layer forming the paraelectric layer B2 are each formed by suffering from a sintering process after being multi-layered, such that a boundary between the adjacent dielectric layers may be integrated enough not to be differentiated from each other.

Further, the ferroelectric layer B1 may be configured of an upper ferroelectric layer B11 and a lower ferroelectric layer B12 as illustrated in FIG. 5, in which the paraelectric layer B2 may be formed to be disposed between the upper ferroelectric layer B11 and the lower ferroelectric layer B12. As such, according to another exemplary embodiment of the present invention, all of some layers having a predetermined thickness is configured of the paraelectric layer B2 having the excellent material strength and bending strength so as to improve the durability of the element.

FIG. 6 is a graph of comparing the bending strength characteristics between the multi-layered capacitor according to the related art in which the overall element is made of a ferroelectric material of barium titanate (BaTiO₃) and the multi-layered capacitor according to the exemplary embodiment of the present invention of FIGS. 4 and 5. At the time of the comparison experiment, the capacitor of 1608 size and 100 nF were used, in which the occurrence ratio of defect of a y coordinate represents a ratio of a product in which the change rate of capacity of the capacitor exceeds 10%.

Referring to FIG. 6, when the bending depth, that is, the substrate is bent by 2 mm, the capacitor related art made of only the ferroelectric material shows the occurrence rate (%) of defect of 30% but in the case of the multi-layered capacitor of FIGS. 4 and 5, it can be appreciated that the occurrence rate (%) of defect appears from when the substrates are each bent by 5 mm and 4 mm.

Herein, when a thickness T₃ of the paraelectric layer B2 is too thick, a deviation in the CTE between the paraelectric layer B2 and the ferroelectric layer B1 is increased, such that the cracks may occur after firing and the overall permittivity of the capacitor may be reduced. To the contrary, when the thickness T₃ of the paraelectric layer B2 is too thin, the bending strength characteristic of the capacitor may be reduced. Therefore, the ratio (T₃/T_{B}) of the thickness T₃ of the paraelectric layer B2 to a thickness T_{B} of the cover part B may be appropriately set within the range of 0.1 to 0.9.

However, since the numerical range is an optimal range set in consideration of the correlation between the bending strength characteristic and the permittivity, and the like, when the numerical range which is slightly deviated from the optimal range meets the object of the present invention, it is apparent to those skilled in the art that the numerical range may be allowed.

According to the exemplary embodiments of the present invention, it is possible to provide the multi-layered capacitor which can be thinned and miniaturized and can have the high capacity and the excellent durability. Further, it is possible to prevent the cracks or the delamination phenomenon, and the like, from occurring in the capacitor due to different characteristics of materials.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A multi-layered capacitor, comprising:
a multi-layered body which includes a capacity part formed by multi-layering a dielectric layer and an internal electrode and a cover part formed by multi-layering the dielectric layer; and
a pair of external terminals disposed on both sides of the multi-layered body,
wherein the cover part is formed by multi-layering a first dielectric layer made of a ferroelectric material and a second dielectric layer made of a paraelectric material.

2. The multi-layered capacitor according to claim 1, wherein the first dielectric layer and the second dielectric layer are alternately multi-layered.

3. The multi-layered capacitor according to claim 1, wherein a ratio (T₁/T₂) of a thickness T₁ of the first dielectric layer to a thickness T₂ of the second dielectric layer is 0.2 to 1.5.

4. The multi-layered capacitor according to claim 1, wherein the cover part is disposed on and beneath the capacity part.

5. The multi-layered capacitor according to claim 1, wherein the ferroelectric material include any one or two or more mixtures selected from a group consisting of barium titanate (BaTiO₃)-based ceramic, Pb-based complex perovskite based ceramic, and strontium titanate (SrTiO₃) based ceramic.

6. The multi-layered capacitor according to claim 1, wherein the paraelectric material includes any one or two or more mixtures selected from a group consisting of calcium zirconate (CaZrO₃)-based ceramic, barium zirconate (BaZrO₃)-based ceramic, and strontium zirconate (SrZrO₃)-based ceramic.

7. The multi-layered capacitor according to claim 1, wherein a dielectric layer forming the capacity part is made of a ferroelectric material.

8. A multi-layered capacitor, comprising:
a multi-layered body which includes a capacity part formed by multi-layering a dielectric layer and an internal electrode and a cover part formed by multi-layering the dielectric layer; and
a pair of external terminals disposed on both sides of the multi-layered body,
wherein the cover part includes a ferroelectric layer formed by multi-layering the dielectric layer made of a ferroelectric material in plural and a paraelectric layer formed by multi-layering the dielectric layer made of a ferroelectric material in plural.

9. The multi-layered capacitor according to claim 8, wherein the ferroelectric layer is configured of an upper ferroelectric layer and a lower ferroelectric layer and the paraelectric layer is disposed between the upper ferroelectric layer and the lower ferroelectric layer.

10. The multi-layered capacitor according to claim 8, wherein a ratio (T₃/T_{B}) of a thickness T₃ of the paraelectric layer to a thickness T_{B} of the cover part is 0.1 to 0.9.
